(19) United States
(12) Patent Application Publication
(10) Pub. No.: US 2008/0126810 A1
(43) Pub. Date: May 29, 2008

(54) Data protection method for optical storage media/device

(76) Inventor: Li-Kuo Chiu, Taipei (TW)

Correspondence Address: BIRCH STEWART KOLASCH & BIRCH, PO BOX 747, FALLS CHURCH, VA, 22040-0747, US

(21) Appl. No.: 11/593,118

(22) Filed: Nov. 6, 2006

(51) Int. Cl. H04L 9/32

(52) U.S. Cl. 713/186

(57) ABSTRACT

The present invention reveals a kind of protection method for optical storage media/device, the controller controls fingerprint sensor to read a fingerprint data waiting to be identified of a user; the end computer uses application program to process fingerprint data waiting to be identified and model fingerprint data stored in the said storage unit or stored in the optical storage media, decides whether both tie, and enable end computer access data of the optical storage media/device if the result is positive, so that the data originally hidden in the optical storage media/device appears on the end computer after decryption algorithm.

### FIELD OF THE INVENTION

The present invention relates to a kind of protection method for optical storage media/device, and more particularly to a kind of portable storage device containing fingerprint sensor and the protection method for its storage data.

### BACKGROUND OF THE INVENTION

Since the storage technology entered optical information storage times, the market size of optical storage product has further expanded with the emergence of low price PC, Internet, and multimedia industry. Under the trend of AV information processing in the near future, there are already significant breakthroughs in the speed and capacity of storage device.

The major applications for optical storage media can be divided into film storage backup and information storage, in particular the video storage backup market. Presently there is still advantage in the optical storage media, as this is related to the content protection issue. In the protection mechanism, optical storage is still better than other storage models. There is also possibility that the video backup market will be replaced by network storage model in future. However, there are still many problems remain to be resolved. For example, the bandwidth issue of network and the content protection issue just mentioned before. As the speed of network bandwidth is still not fast enough, there is still no replacement for the optical storage media for larger films or data files.

On the other hand, with the invention of chip fingerprint sensor, smaller size electronic product integrated with fingerprint identification device is no longer difficult technology. This has also open up a kind of brand-new personalized application, i.e. portable personal ID electronic key with fingerprint identification function.

Particularly in the protection of storage media aspect, it is an important item for development combining biological identification method. For example, the U.S. Pat. No. 4,582,985 has already revealed a kind of storage media protection method, where fingerprint authentication was used for the protection of personal information stored in the personal ID device. After the process of fingerprint identification procedure, the protected information stored in the card device can be output for subsequent processing or authentication procedure. The lateral size of such kind of device is similar to the credit card commonly used today. It mainly contains a fingerprint sensor, image processing and identification module, and storage memory and is a completely independent fingerprint identification device (i.e. fingerprint accessing and identification are executed in the same device).

U.S. Pat. No. 6,213,403, World Patent WO 02/42887A2, U.S. Pat. No. 6,213,403, European Patent EP124079A1, U.S. Patent Public No. 2003/005337, U.K., Patent No. GB2387933 Bulletins all reveal a kind of fingerprint identification for the protection of information inside the memory. These are similar to the storage device with fingerprint sensor revealed in the U.S. Pat. No. 4,582,985 Bulletin (i.e. fingerprint accessing and identification are executed in the same device).

Thus far, the common feature of conventional techniques is also to provide an independent fingerprint identification device internally contains fingerprint sensor as well as fingerprint image processing and identification IC. The advantage of such design perhaps does not need to install fingerprint application program in the host computer and provides the convenience of hot plug. However, another important problem is derived, i.e. expensive in price. This is because the cost of an additional fingerprint image processor and identification IC and its accompanied design, usually the IC is a 32-bit RISC or DSP in order to carry out fingerprint identification quickly. The cost of processor usually increases with the increase in computational speed and processing capability.

In view of this, this invention is to recommend a kind of information protection method for optical storage media/device in order to resolve the problems in the conventional art.

### SUMMARY OF THE INVENTION

This invention is also related to part of the patents of the following inventors: (a) Republic of China Patent No. 092133887 of Li-kuo Chiu, Min-shuen Chen, Mao-yuan Ku, In-chang Chen, and Cheng-shan Chou, filed on Dec. 2, 2003. Name of the patent is “Memory storage device containing fingerprint sensor and the protection method of its stored data”. (b) Republic of China Patent No. 093112282 of Li-kuo Chiu and Cheng-shan Chou, filed on Apr. 30, 2004. Name of the patent is “Portable encryption storage device containing biological print and the protection method of its stored data”.

The main object of the present invention is to provide a kind of portable electronic ID key device containing fingerprint sensor. The said portable storage device is for the connection to an end computer and through the communication with the said end computer it is possible to provide a portable storage device containing fingerprint sensor without incurring significant cost increase by using user's fingerprint character data to replace password as the person's identification.

Another purpose of the present invention is to provide a kind of electronic ID key device containing fingerprint sensor; whereas it could access the hidden fingerprint sensor and storage unit of an end computer for the simplification of controlling method to the said end computer; the storage unit of such device can be divided into two blocks, one of which is a read-only space for the storage of fingerprint application programs that system could read out from; the other is a hidden block whereas the system is not able to detect, therefore the block is for the storage of privacy data of user's fingerprint characteristic data, information, program, encrypted golden key, and electronic authentication, etc and processed through encryption/decryption in order to provide complete protecting and hiding method.

Still another purpose of the present invention is to store application programs and database to the optical storage media/device. Data or program user intends to protect are stored in the database of the application program, then encrypt and store in the optical storage media/device. At the same time, any data stored in the optical storage media/device of this device is stored in encrypted form, and not even any compatible optical storage device could access the correct format and content of the optical storage media. Here the encryption/decryption processing of privacy data intended for protection is downloaded to end computer and processed by the application program.

To achieve above stated object, the present invention provides a kind of electronic ID key device containing fingerprint sensor for connection to an end computer. The said portable, large capacity storage device includes a host interface, for the connection to the said end computer; a controller, for connecting to the said host interface; a fingerprint sensor, for connecting to the said controller for sensing the fingerprint data of a user waiting to be identified; and the interface and its storage unit for connecting to storage device, connecting to the said controller. Controller divides storage unit into several disks. Such method is accomplished by the controller instead of the host computer. To the host, each disk described above is a real disk to the host computer and not logical disk. And a disk still can be divided into multiple zones. All end users can freely access some zones, but only some designated users can access certain zones through authentication.

With this, it is possible to realize the function of protecting data or privacy function. The controller can divide the storage unit into two regions including a public block, for storing several application programs; and a hidden block, for storing a model fingerprint data, encrypted golden key, and for the storage of user database waiting for protection. Once the electronic ID key device is inserted into the insertion slot of the host computer, the controller will read the information block from the SRAM of the controller after initial power on. Based on the data of information block loaded into SRAM, the controller will react to the request issued by the host computer by reconfiguring the storage unit and treat it as logical disk. Host computer will store the application program of the public block read from the storage unit and run the said program from the said host computer. The said controller will transmit the said model fingerprint data to the said host computer. The said host computer will access data through the said logical disk and receive an instruction from the user in order to notify the said controller to control the said fingerprint data of the user waiting to be authenticated, and transmit the said fingerprint data waiting to be authenticated to the said host computer. The said end computer uses the said application program to process the fingerprint data waiting for authentication and the said model fingerprint data, and decide whether both physically ties, and enable the database of the user in the optical storage media/device when both physically ties, and maps into a logical disk in order to allow the said end computer to access data, or to disable the user database in the optical storage media/device so as to prevent accessing data from the said end computer. For the same reason, more than one user database can be established and maps to more than one corresponding logical disk at the end computer. The method of building up the model fingerprint data is as shown below. The said controller communicates with the said end computer through the said host interface, and instructs the said end computer to load and install one of the driver programs and one of the application programs suitable to the end computer to the said end computer. The said end computer receives an instruction from an authorized user through the said driver program and the said application program, in order to notify the said controller to control the said fingerprint sensor to read the said model fingerprint data of the authorized user, and transmit the said model fingerprint data to the said end computer. The said end computer uses the said application program to process the said model fingerprint data, and transmit the said model fingerprint data processed to the said hidden block for storage or encrypt to become the user's electronic signature and then store into the optical storage media.

Below is the detailed description through the embodiment and the attached diagrams. It should be easier to understand the object of this invention, technical content, features, and the performance intend to achieve.

### BRIEF DESCRIPTION OF THE DRAWINGS

FIG. 1 illustrates the first embodiment of ID electronic key device of this invention having a fingerprint sensor and the connection with a host computer;

FIG. 2 illustrates the application system flowchart of a portable large capacity storage device with fingerprint sensor.

### DETAILED DESCRIPTION OF THE PREFERRED EMBODIMENTS

In order for the committee's convenience in understanding other features and advantages of this invention as well as to manifest the performance achieved, this invention together with illustrations are explained in detail as below:

The feature of this invention is in resolving the three major problems in conventional technology.

First problem is in that the present invention is to carry out the fingerprint image processing and identification by making use of the microprocessor of the host computer for the replacement of the fingerprint identification of the conventional technology in order to drastically reduce the manufacturing cost.

Second problem is that though there is no independent fingerprint identification processor, it is however possible to automatically download the fingerprint application program to the end system for use and not necessary to install into the end system by human intervention. This makes the present invention portable, which is convenient for use in different end system.

Third is that though the present invention is using optical storage media/device for storing information, the user information stored in it however could be encrypted during storage and hidden so that it could not be detected by the end system and further won't be deciphered. When user is authenticated by the automatically downloaded fingerprint application program in the end system and successfully authenticated, the user information database in the optical storage media/device is enabled and maps into a logical disk for the access by the end computer and achieve the purpose of complete protecting information and hiding information.

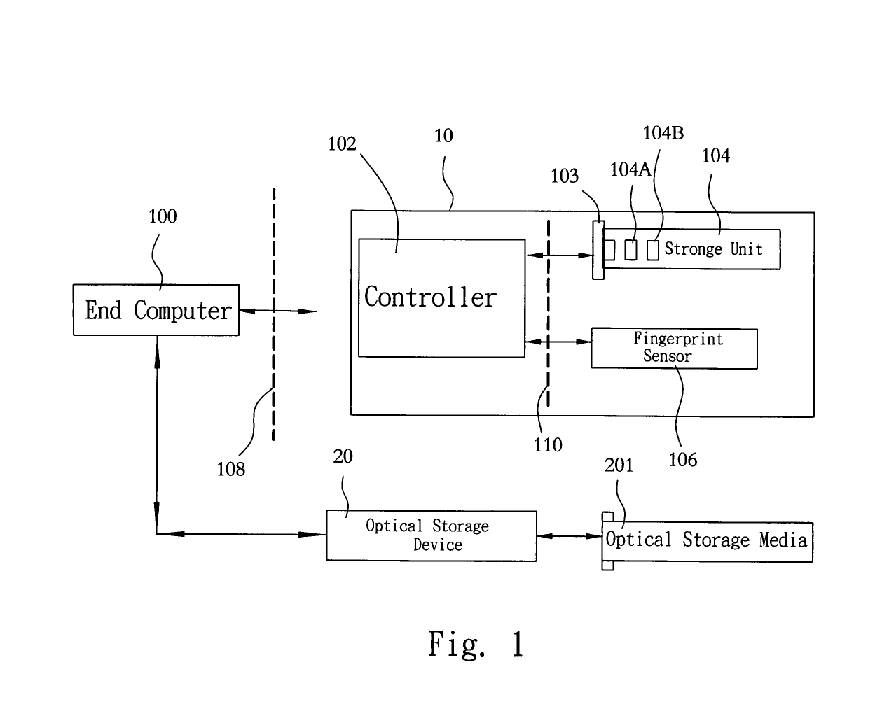

FIG. 1 shows the functional block diagram of the electronic ID key device 10 with fingerprint sensor of the embodiment of present invention. The said device 10 basically contains a controller 102, a storage device interface 103 and storage unit 104, a fingerprint sensor 106 and a host interface 108. In the present embodiment, the storage device interface 103 is a PCMCIA interface, CF interface, Memory Stick interface, SD interface, xD interface or other standard interfaces. In this way, this device can provide protection method for any external memory data. The host interface is Universal Serial Bus (USB) interface, but could also be PCMCIA interface, PCI Express interface or an IEEE 1394 interface or any other stand interface. The host USB interface 108 is connected to the end computer 100, and the controller 102 is connected to the host interface 108 so that controller 102 is connected to end computer 100 of the end computer though the host interface 108 and is connected to the storage unit 104 through storage device interface 103. The mission of controller 102 is to communicate with end computer 100 and at the same time manage storage unit 104 and fingerprint sensor 106. Storage unit 104 must include at least one storage chip, memory, or any other storage unit for storing data, such as flash memory, PROM, disk, or any other EPROM, etc. The large capacity storage unit 104 is divided into: a public block 104A for the storage of including at least an application program containing a fingerprint application program; and a hidden block 104B for the storage of at least one model fingerprint data, or even can store an encrypt/decrypt golden key, and the said controller 102 can further transmit the said encrypt/decrypt golden key to the said end computer 100, or encrypt the above stated user private information to become the electronic signature of the said user and then store into optical storage media 201; as the authentication matches, the application of the end computer 100 is used to enable the user database in the optical storage media 201 and then decrypt the data accessed from optical storage media 201 waiting to be protected through decrypt golden key. Here the processing of data to be protected using decrypting method refers to the processing through the application program downloaded to end computer 100, or processing through the encrypting/decrypting engine of optical storage device 201 for the instant decryption of reading information in the optical storage media 201; in contrast, the user information written into optical storage media 201 has already been encrypted. The optical storage media 201 of this embodiment is DVD-R/CD-R storage media. However, it could be CD-ROM/DVD-ROM storage media, optical magnetic storage media, blue-light disk storage media, interface varying media, HD-DVD storage media, close to optical device, full image photography storage media, and any other media of optical storage standard.

Fingerprint sensor 106 contains area type fingerprint sensor for sensing the fingerprint placed on its top, or the sliding type fingerprint sensor for sensing the fingerprint sliding across its top. Controller 102 controls the fingerprint sensor 106 for the accessing of instant fingerprint data. End computer 100 will take the instant fingerprint data accessed and compare with the model fingerprint data. The so-called model fingerprint data is the fingerprint data used for registration of the electronic ID key device 10. Such fingerprint data is used as the standard for comparison with subsequent fingerprint data. Therefore, fingerprint sensor 106 is connected to the said controller 102 in order to sense the model fingerprint data of the authorized user, and further for sensing the fingerprint data of a user waiting for authentication by comparing with model fingerprint data.

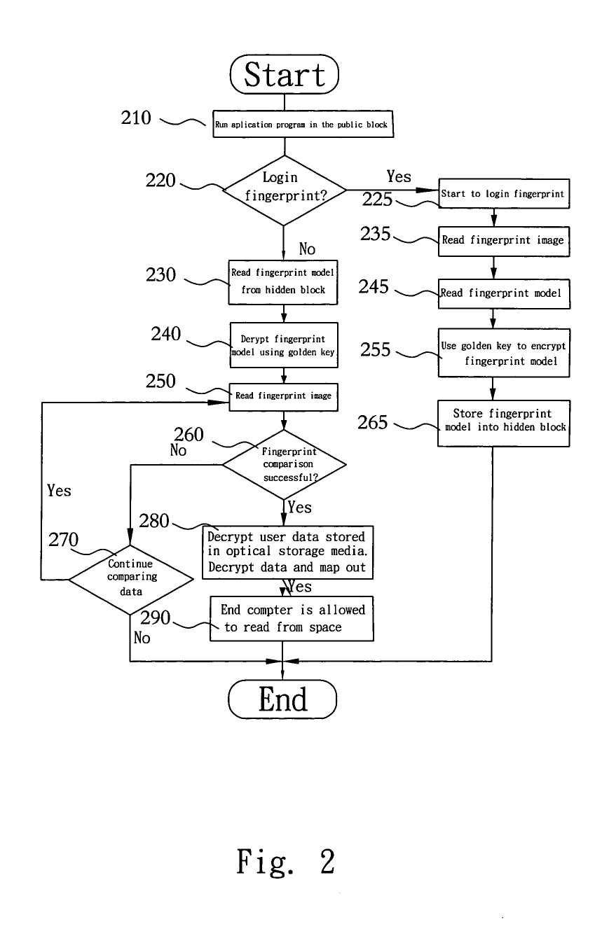

Please refer to FIG. 1 and FIG. 2 at the same time. The protection method of the stored data of the electronic ID key device 10 of the present invention after connecting to the end computer 100 is as explained below. First, controller 102 communicates with end computer 100 through host interface 108, and orders the end computer 100 to load and install the driver program and fingerprint application program suitable for the operating system of the end computer 100, as shown in step 210. Then, during step 220, the end computer 100 shows a window for user to select or automatically decide to enter a fingerprint login mode (step 225) or a fingerprint authentication mode (step 230).

To enter fingerprint login mode, end computer 100 will notify controller 102 to control fingerprint sensor 106 to read the model fingerprint data of the authorized user and transmit the model fingerprint data to end computer 100 (step 235, 245). At this time, end computer 100 uses fingerprint application program to process model fingerprint data and transmit the processed model fingerprint data to hidden block 104B for storage. Or, the fingerprint application program can make use of golden key to encrypt fingerprint model data (step 255) then transmit the encrypted model fingerprint data to hidden block 104B for storage (step 265).

To enter fingerprint authentication mode, controller 102 reads model fingerprint data from hidden block 104B (step 230) so that the model fingerprint data can be transmitted to end computer 100, then the golden key is used to decrypt the fingerprint model data (step 240). After that, end computer 100 notify controller 102 to control fingerprint sensor 106 to read the user's fingerprint data waiting to be identified and transmit the fingerprint data waiting to be identified to end computer 100 (step 250). Then, end computer 100 uses application program to process fingerprint data waiting for identification and model fingerprint data, and decides whether both tie in reality. On both data tie in reality, the user database in the optical storage media 201 is enabled, and maps into a logical disk in order for the said end computer 100 to access data (step 280), or disable the user database of the said optical storage media 201 in order to prevent the said end computer 100 being accessed or to question user whether continue to compare data for authentication (step 270).

In brief, the method of controller 102 managing storage unit 104 used in the present invention will divide the said large capacity storage unit into different independent blocks for the storage of different data. Taking the embodiment of this invention as an example, the said large capacity storage unit 104 is divided into a public block 104A and a hidden block 104B. Please refer to FIG. 3.

After connecting the setup of this invention with end system, the end system will treat this setup as an independent disk and automatically connect the independent public block 104A in the memory module 104 in order to display the file selection items of fingerprint application program on the display device of the end system and allow user's selection in order to execute the said fingerprint application program, e.g. a fingerprint comparison screen appears.

After user completes the execution of the fingerprint application program in the said public block 104A, controller 102 will automatically reads the user database of optical storage media 201 and maps into a logical disk in order for the said end computer 100 to access data, and the corresponding logical disk of a user's database in the optical storage media 201 is called virtual logical disk in short. In contrast, the switching of screen will appear on the display device of the end system, i.e. switching to the virtual logical disk of the protected optical storage media 201 in order to display the protected data in the said block for the user to access data.

In short, when using the setup of the present invention controller 102 will first switch to public block and automatically download fingerprint application program and wait for the completion of fingerprint application program before switching to the virtual logical disk of the optical storage media 201. Such function of automatically downloading and switching screen is also revealed in the invention patent application No. 092133887 of the Republic of China dated Dec. 2, 2003 filed by the applicant of this invention, name of the invention is “memory storage device containing fingerprint sensor and the protection method of its stored data”, which resolves the controller 102 designed with memory independent division and management function of the above stated patent and allows the setup of this invention to differentiate from the conventional technology, to process and identify fingerprint through microprocessor of the end system, and also to automatically download all kinds of application programs containing fingerprint application programs.

One thing worth mentioning is that any application program in the public block of the present invention is read-only file and cannot be changed in any way. There is another hidden block 104B of the present invention that must communicate with controller 102 directly through special program. System has no way to detect this block. The size of hidden block 104B can be adjusted according to the design. The hidden block stores private information including model fingerprint data, encrypting golden key, electronic authentication, and user database, etc.

On successful authentication, the user database in the optical storage media is enabled and maps into a logical disk in order for the end computer to access, or the user database in the optical storage media/device is disabled in order to prevent the said end computer being accessed. For the same reason, it is possible to build more than one user database, and maps more than one corresponding logical disk at the end computer. Depending on the need, it is also possible to divide the space of user database in the optical storage media into several different user databases. At this time, the disks mapped by the present device faced by end system could have several different corresponding user databases and with several different corresponding virtual logical disks. Therefore, this device can display several different virtual logical disks in the end system. Such virtual logical disks could display different disk name, and user could read data from the space represented by such disk name. When user is reading the data under such disk name, the name can be clearly displayed. The decryption of data will be handled when reading the data in the optical storage media.

In addition, it is possible to display the application programs originally stored in the public block 104A of the electronic ID key device into the optical storage media, and process the private data originally hidden in block 104B including model fingerprint data, encrypted golden key, electronic authentication, and user database in encrypted method into the electronic signature of the said user and stores into the optical storage media. Therefore, so long as the optical storage media is placed into the optical storage device of the end system, the application programs of the optical storage media will be loaded and the file selection items of the fingerprint application program will be automatically displayed for user's selection for the execution of the said fingerprint application program, e.g. a fingerprint comparison screen appears on the display. Then, the user's electronic signature of the optical storage media is read and the electronic ID key device is driven to capture the instant user fingerprint image for comparison of model fingerprint data in the electronic signature. If the data tie, the user database in the optical storage media is enabled and maps into a logical disk for the said end computer to access data, or the user database in the optical storage media is disable in order to prevent the said end computer from accessing data.

For the same reason, user's electronic signature stored in the optical storage media could be more than one in order to build up same data for the several users in the optical storage media; or the space of the user database in the optical storage media can be divided into several different user databases and enabled by different users. At this time, the disk of the present setup mapped by the end system can have several different user databases corresponding to several different virtual logical disks. Therefore, such device could display several different virtual logical disks in the end system.

Through the structure of the present invention described above, the connecting device seen from the computer system no longer contains a non-volatile memory and a fingerprint sensor and therefore there it is not necessary to install the drivers suitable for the said non-volatile memory and the said fingerprint sensor. Therefore, computer system no longer requires the operation of two devices controlled in multiplex. What is in place is the connecting device seen from the computer system that only one portable storage device is available. Therefore, the computer system only needs to control the operation of a device. At to the operation of non-volatile memory and fingerprint sensor, the controller can perform the control. What is worth noticing is that the controller of the present invention can widely include other components for the control of operation of non-volatile memory and fingerprint sensor, such as ROM, and RAM, etc.

And the electronic ID key device can be for public or private use, but the encrypted storage of data in the optical storage media can be safely activated and not being accessed through unauthorized means.

In summary, the present invention has indeed achieved the performance intended through breakthrough of structure of prior technology and is by no means achievable by users familiar to the art. In addition, the present invention has never been open to public prior to this application. The advancement and practicality of this invention obviously meet the requirement of the patent application of invention. The patent is therefore applied according to the law. Your approval of this application is highly appreciated.

What is claimed is:

1. A kind of electronic ID key device connecting to an end computer; the said portable large capacity storage unit contains:
A host interface, for the connection to the said end computer;
A controller, for the connection to the said host interface;
A fingerprint sensor, for the connection to the said controller for the sensing of the fingerprint data of the user waiting to be identified;
A storage interface and a storage unit, for the connection to the said controller, the said storage unit is divided into a public block, for the storage of several driver programs and several application programs; a hidden block, for the storage of a model fingerprint data, a data waiting to be protected, where the said controller handshakes and communicates with the said end computer through the said host interface, and orders the said end computer to load and install a driver program and one of the application programs into the said end computer, the said controller to transmit the said model fingerprint data to the said end computer, the said end computer to receive the instruction from the said user through the said driver program and the said application program, in order to notify the said controller to control the said fingerprint sensor to read the fingerprint data of the said user waiting to be identified, and to transmit the said fingerprint data to the said end computer; and the said end computer to use the said application program to process the said fingerprint data waiting to be identified and the said model fingerprint data, and decides whether both tie in reality, and on tie in reality resolves the enabling of the user's database in the hidden block, and maps into a logical disk for the said end computer to access data, or disables the user's database of the said hidden block in order to prevent the said end computer from accessing data.

2. As the electronic ID key device containing fingerprint sensor stated in claim 1, where the said hidden block stores an encryption/decryption golden key, and the said controller could further transmit the said encryption/decryption golden key to the said end computer.

3. As the electronic ID key device containing fingerprint sensor stated in claim 2, where the said application program of the said end computer is to enable the user database in the optical storage media and to decrypt the said database of the user through the said decryption golden key in order for the user to access data.

4. As the electronic ID key device containing fingerprint sensor stated in claim 1, where the said host interface is a universal serial bus (USB) interface, a PCMCIS interface, a PCI Express interface, or an IEEE 1394 interface.

5. As the electronic ID key device containing fingerprint sensor stated in claim 1, where the said storage device interface is a Smart Media interface (NAND Flash interface), or can be a PCMCIA interface, CF interface, IDE interface, Memory Stick interface, SD interface, XD interface, or interface of other standard. Thus the present device can provide any protection method of any external memory.

6. As the electronic ID key device containing fingerprint sensor stated in claim 1, where the said fingerprint sensor is an area type fingerprint sensor or sliding type fingerprint sensor.

7. As the optical storage media stated in claim 1 is DVD-R/CD-R storage media, or can be CD-ROM/DVD-ROM storage media, optical magnetic storage media, Blue-light Disk (BD) storage media, interface changing media, HD-DVD storage media, close-to-optical device, full image photography storage media and media of any other optical storage standard.

8. Protection method of the data of a kind of optical storage media/device, the said electronic ID key device contains a host interface, for the connection with the said end computer; a controller, for the connection to the said host interface; a fingerprint sensor, for connection to the said controller for the sensing of the model fingerprint data of an authorized user; and a storage unit, connected to the said controller through a storage device interface, the said storage unit is divided into a public block, for the storage of several driver programs and several application programs; a secret block, for the storage of data to be protected, after the connection of the said electronic ID key device to the end computer, the said protection method includes the following steps:
The said controller communicates through the said host interface, orders the said driver and application programs in the said storage unit to be loaded and installed to the end computer; when enters a fingerprint login mode or a fingerprint authentication mode, the said end computer will notify the said controller to control the said fingerprint sensor to read the said model fingerprint data of the said authorized user, and transmit the said model fingerprint data to the said end computer;
The said end computer uses the said application program to process the said model fingerprint data, and after processing the said model fingerprint data is transmitted to the said hidden blocks, or encrypted to become the electronic signature of the said user, and then stored in the optical storage media; in the said fingerprint authentication mode, the controller is used to transmit the model fingerprint data to the said end computer;
The said end computer notify the said controller to control the said fingerprint sensor to read a piece of fingerprint data of a user waiting to be identified, and the said fingerprint data waiting to be identified is transmitted to the said end computer; and
The said end computer uses the said application program to process the said fingerprint data waiting to be identified and the said model fingerprint data, and decides whether the two matches in reality, and on matching the user database in the optical storage media/device is enabled, and a virtual logical disk is generated for the host to read data, or to disable the user database hidden in the blocks in order to prevent the host from being read.

9. As the protection method of the data of the optical storage media/device stated in claim 8 the space of the optical storage media can be divided into several different user database, wherein the disk mapped by the present device of the end system can be mapped to the corresponding several different user databases, the several different virtual logical disks can display several different virtual logical disk in the end system.

10. As the protection method of the data of the optical storage media/device stated in claim 8 when the user database of the optical storage media is enabled, the virtual logical disk in the end system will display the name of the disk, therefore user could read the data in the space under the disk name, the data under such disk name read by the user will be decrypted and displayed in the end system; in contrast, when the user database of the optical storage media is disabled, the user's data will be hidden.

11. As the protection method of the data of the optical storage media/device stated in claim 8 the user electronic signature in the said optical storage media can be more than one in order to establish several users in using the same data of the optical storage media; the space of the user database can also be divided into several different user databases, enabled by different users. At this time, the end system facing the disk mapped by the present device, can map to the corresponding several different user databases, therefore such device in the end system can display several different virtual logical disks. The application program should control the logic of using such activated user database.

12. As the protection method of the data of the optical storage media/device stated in claim 8 where the hidden block of the storage unit of the said electronic ID key device is for the storage of an encryption/decryption golden key or for using optical storage media to store the user's electronic signature containing encryption/decryption golden key. The application program will transmit the said encryption/decryption golden key to the said end computer, and the said application program of the said end computer is to enable user database of the optical storage media through the said encryption/decryption golden key, and decrypt the said read data waiting to be protected.

13. As the protection method of the data of the optical storage media/device containing fingerprint sensor stated in claim 8 where the optical storage device can also have build-in encryption/decryption engine, jointly operating by the application program and electronic ID key device, to write into the optical storage media of such optical storage device, but must be authenticated before the user database of the optical storage media is enabled, by displaying disk name in the end system for the virtual logical disk, therefore user could read data in the space under such disk name; such encryption/decryption operation are instantly processed by the build-in encryption/decryption engine of the optical storage device.
